(19) United States
(12) Patent Application Publication
(10) Pub. No.: US 2024/0270919 A1
(43) Pub. Date: Aug. 15, 2024

(54) COMPOSITION FOR PRODUCING POROUS FILM, METHOD FOR PRODUCING POROUS FILM, AND POROUS FILM

(71) Applicant: TOKYO OHKA KOGYO CO., LTD., Kanagawa (JP)

(72) Inventors: Takuya NOGUCHI, Kanagawa (JP); Satoshi AKIYAMA, Kanagawa (JP)

(21) Appl. No.: 18/430,987

(22) Filed: Feb. 2, 2024

(30) Foreign Application Priority Data
Feb. 3, 2023 (JP) 2023-015064

(51) Int. Cl. C08J 9/26; C08J 5/18

(52) U.S. Cl. CPC C08J 9/26; C08J 5/18; C08J 2201/0442; C08J 2377/00

(57) ABSTRACT

Provided are a composition for producing a porous film the composition enabling a decrease in a pore diameter of a produced porous film and improvement of a flow rate through the porous film, a method for producing a porous film, and a porous film. A composition for producing a porous film, the composition comprising at least one resin component (A) selected from a group consisting of polyamide acid, polyimide, a polyamide-imide precursor, polyamide-imide, and polyethersulfone, fine particles (B), and a solvent (S), the fine particles (B) comprising fine particles (B1) and fine particles (B2) having an average particle diameter larger than that of the fine particles (B1), the fine particles (B1) having an average particle diameter of smaller than 100 nm.

This application is based on and claims the benefit of priority from Japanese Patent Application No. 2023-015064, filed on 3 Feb. 2023, the content of which is incorporated herein by reference.

### BACKGROUND OF THE INVENTION

### Field of the Invention

The present invention relates to a composition for producing a porous film, a method for producing a porous film, and a porous film.

### Related Art

Conventionally, various porous films have been used for a filter as a film for separation of gas or liquid, and the like. Furthermore, in recent years, application of porous films to separators for secondary batteries such as lithium batteries has also been progressed.

Examples of the well-known method for producing a polyimide porous film include a method which includes applying a varnish obtained by dispersing silica particles in a solution of polyamide acid or polyimide onto a substrate to form a coating film, then heating the coating film as necessary so as to obtain a polyimide film containing silica particles, and then removing silica in the polyimide film by elution using a hydrogen fluoride solution so as to make the film porous (see Patent Document 1).
Patent Document 1: Japanese Patent No. 5605566

### SUMMARY OF THE INVENTION

As the above-mentioned porous film, a porous film having a small pore diameter is required. For example, when producing a semiconductor, a porous film is used as a filter for removing foreign matters contained in a washing liquid, a coating liquid, or the like. As semiconductors become finer, foreign matters that cause defects also become smaller. A porous film having a small pore diameter is required to collect small foreign matters. A porous film having a small pore diameter can be produced by using a composition (varnish) for producing a porous film, containing fine particles such as silica with a small particle diameter. However, when the pore diameter of the porous film is reduced, problems are caused, e.g., permeation properties (liquid permeation property or air permeation property) of the porous film deteriorate, and a flow rate of a liquid or gas permeating through the porous film decreases.

The present invention has been made in view of the above-mentioned circumstances, and an object of the present invention is to provide a composition for producing a porous film the composition enabling a decrease in a pore diameter of a produced porous film and improvement of a flow rate through the porous film, a method for producing a porous film, and a porous film.

In order to solve the above-mentioned problems, the present inventors have conducted extensive studies. As a result, they have found that the above-mentioned problems can be solved by a composition for producing a porous film, containing at least one resin component (A) selected from a group consisting of polyamide acid, polyimide, a polyamide-imide precursor, polyamide-imide, and polyethersulfone, fine particles (B), and a solvent (S), the fine particles (B) including fine particles (B1) and fine particles (B2) having an average particle diameter larger than that of the fine particles (B1), and the fine particles (B1) having an average particle diameter of smaller than 100 nm. This finding has completed the present invention. Specifically, the present invention provides the following aspects.

[1] A composition for producing a porous film, the composition comprising at least one resin component (A) selected from a group consisting of polyamide acid, polyimide, a polyamide-imide precursor, polyamide-imide, and polyethersulfone, fine particles (B), and a solvent (S), the fine particles (B) comprising fine particles (B1) and fine particles (B2) having an average particle diameter larger than that of the fine particles (B1), the fine particles (B1) having an average particle diameter of smaller than 100 nm.

[2] The composition according to [1], wherein a ratio (D2/D1) of the average particle diameter (D2) of the fine particles (B2) to the average particle diameter (D1) of the fine particles (B1) is 1.2 to 6.0.

[3] The composition according to [1] or [2], wherein the fine particles (B) are inorganic oxide fine particles.

[4] The composition according to [3], wherein the fine particles (B) are at least one selected from a group consisting of silica fine particles, titanium oxide fine particles, and alumina fine particles.

[5] The composition according to any one of [1] to [4], wherein a ratio of a mass of the fine particles (B2) to a mass of the fine particles (B1) is 0.10 to 0.90.

[6] A method for producing a porous film, comprising: forming, on a substrate, a composite film made of the composition for producing a porous film according to any one of [1] to [5]; and removing the fine particles from the composite film.

[7] The method according to [6], wherein the resin component (A) comprises at least one of polyamide acid or a polyamide-imide precursor, and the method comprises burning the composite film after forming the composite film and before removing the fine particles.

[8] A porous film comprising at least one resin component selected from a group consisting of polyimide, polyamide-imide, and polyethersulfone, the porous film being produced by a production method comprising: forming, on a substrate, a composite film made of the composition for producing a porous film according to any one of [1] to [5]; and removing the fine particles from the composite film.

According to the present invention, it is possible to provide a composition for producing a porous film, the composition enabling a decrease in a pore diameter of a produced porous film and improvement of a flow rate through the porous film, a method for producing a porous film, and a porous film.

### DETAILED DESCRIPTION OF THE INVENTION

Hereinafter, embodiments of the present invention will be described in detail, but the present invention is not necessarily limited to the following embodiments and can be implemented with appropriate modifications within the purpose of the present invention.

### <<Composition for Producing Porous Film>>

The composition (hereinafter also referred to as “varnish”) for producing the porous film contains at least one resin component (A) selected from a group consisting of polyamide acid, polyimide, a polyamide-imide precursor, polyamide-imide, and polyethersulfone, fine particles (B), and a solvent (S). The fine particles (B) include fine particles (B1) and fine particles (B2) having an average particle diameter larger than that of the fine particles (B1). The fine particles (B1) have an average particle diameter of smaller than 100 nm.

### [Resin Component (A)]

As described above, the composition for producing a porous film contains at least one resin component (A) selected from a group consisting of polyamide acid, polyimide, a polyamide-imide precursor, polyamide-imide, and polyethersulfone. These resin components (A) will be explained below.

### [Polyamide Acid]

The polyamide acid may be any one prepared by polymerizing appropriate tetracarboxylic dianhydride and diamine. The amounts of the tetracarboxylic dianhydride and the diamine to be used are not particularly limited, and the amount of the diamine is preferably 0.50 to 1.50 mol, more preferably 0.60 to 1.30 mol, and particularly preferably 0.70 to 1.20 mol, based on 1 mol of the tetracarboxylic dianhydride.

The tetracarboxylic dianhydride can be appropriately selected from tetracarboxylic dianhydrides that have been conventionally used as raw materials for synthesizing polyamide acids. The tetracarboxylic dianhydride may be an aromatic tetracarboxylic dianhydride or an aliphatic tetracarboxylic dianhydride, but from the viewpoint of the heat resistance of the resulting polyimide resin, an aromatic tetracarboxylic dianhydride is preferably used. One type of tetracarboxylic dianhydride may be used alone or may be used in a combination of two or more types thereof.

Preferred examples of the aromatic tetracarboxylic dianhydride include pyromellitic dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 3,3′,4,4′-biphenyltetracarboxylic dianhydride, 2,3,3′,4′-biphenyltetracarboxylic dianhydride, 2,2,6,6-biphenyltetracarboxylic dianhydride, 2,2-bis(3,4-dicarboxyphenyl)propane dianhydride, 2,2-bis(2,3-dicarboxyphenyl)propane dianhydride, 2,2-bis(3,4-dicarboxyphenyl)-1,1,1,3,3,3-hexafluoropropane dianhydride, 2,2-bis(2,3-dicarboxyphenyl)-1,1,1,3,3,3-hexafluoropropane dianhydride, 3,3′,4,4′-benzophenonetetracarboxylic dianhydride, bis(3,4-dicarboxyphenyl)ether dianhydride, bis(2,3-dicarboxyphenyl)ether dianhydride, 2,2′,3,3′-benzophenonetetracarboxylic dianhydride, 4,4-(p-phenylenedioxy)diphthalic dianhydride, 4,4-(m-phenylenedioxy)diphthalic dianhydride, 1,2,5,6-naphthalenetetracarboxylic dianhydride, 1,4,5,8-naphthalenetetracarboxylic dianhydride, 2,3,6,7-naphthalenetetracarboxylic dianhydride, 1,2,3,4-benzenetetracarboxylic dianhydride, 3,4,9,10-perylenetetracarboxylic dianhydride, 2,3,6,7-anthracenetetracarboxylic dianhydride, 1,2,7,8-phenanthrenetetracarboxylic dianhydride, 9,9-bisphthalic anhydride fluorene, and 3,3′,4,4′-diphenylsulfonetetracarboxylic dianhydride. Examples of the aliphatic tetracarboxylic dianhydride include ethylenetetracarboxylic dianhydride, butanetetracarboxylic dianhydride, cyclopentanetetracarboxylic dianhydride, cyclohexanetetracarboxylic dianhydride, 1,2,4,5-cyclohexanetetracarboxylic dianhydride, and 1,2,3,4-cyclohexanetetracarboxylic dianhydride. Among them, 3,3′,4,4′-biphenyltetracarboxylic dianhydride and pyromellitic dianhydride are preferred because of their inexpensiveness and ready availability. One type of tetracarboxylic dianhydride may be used alone or as a mixture of two or more types thereof.

The diamine can be appropriately selected from diamines that have been conventionally used as raw materials for synthesizing polyamide acids. The diamine may be an aromatic diamine or an aliphatic diamine, but from the viewpoint of the heat resistance of the resulting polyimide resin, an aromatic diamine is preferred. One type of these diamine may be used alone or in a combination of two or more types thereof.

Examples of the aromatic diamine include diamino compounds having one phenyl group or about two to ten phenyl groups. Specifically, examples of the aromatic diamine include phenylenediamines and their derivatives, diaminobiphenyl compounds and their derivatives, diaminodiphenyl compounds and their derivatives, diaminotriphenyl compounds and their derivatives, diaminonaphthalenes and their derivatives, aminophenylaminoindanes and their derivatives, diaminotetraphenyl compounds and their derivatives, diaminohexaphenyl compounds and their derivatives, and cardo-type fluorenediamine derivatives.

The phenylenediamines are, for example, m-phenylenediamine and p-phenylenediamine. The phenylenediamine derivatives are diamines to which alkyl groups, such as a methyl group or an ethyl group, are bound, such as 2,4-diaminotoluene and 2,4-triphenylenediamine.

In the diaminodiphenyl compounds, two aminophenyl groups are bonded to each other. For example, the diaminodiphenyl compounds are 4,4′-diaminobiphenyl and 4,4′-diamino-2,2′-bis(trifluoromethyl)biphenyl.

The diaminodiphenyl compound is a compound obtained by linkage of two aminophenyl groups at their phenyl groups via another group. The linkage is, for example, an ether linkage, a sulfonyl linkage, a thioether linkage, a linkage of an alkylene or its derivative group, an imino linkage, an azo linkage, a phosphine oxide linkage, an amide linkage, or an ureylene linkage. The number of carbon atoms of the alkylene linkage is about 1 to 6. The derivative groups is an alkylene group whose one or more hydrogen atoms have been replaced by, for example, halogen atoms.

Examples of the diaminodiphenyl compounds include 3,3′-diaminodiphenyl ether, 3,4′-diaminodiphenyl ether, 4,4′-diaminodiphenyl ether, 3,3′-diaminodiphenyl sulfone, 3,4′-diaminodiphenyl sulfone, 4,4′-diaminodiphenyl sulfone, 3,3′-diaminodiphenyl methane, 3,4′-diaminodiphenyl methane, 4,4′-diaminodiphenyl methane, 4,4′-diaminodiphenyl sulfide, 3,3′-diaminodiphenyl ketone, 3,4′-diaminodiphenyl ketone, 2,2-bis(p-aminophenyl)propane, 2,2′-bis (p-aminophenyl)hexafluoropropane, 4-methyl-2,4-bis (p-aminophenyl)-1-pentene, 4-methyl-2,4-bis(p-aminophenyl)-2-pentene, iminodianiline, 4-methyl-2,4-bis (p-aminophenyl)pentane, bis(p-aminophenyl)phosphine oxide, 4,4′-diaminoazobenzene, 4,4′-diaminodiphenylurea, 4,4′-diaminodiphenylamide, 1,4-bis(4-aminophenoxy)benzene, 1,3-bis(4-aminophenoxy)benzene, 1,3-bis (3-aminophenoxy)benzene, 4,4′-bis(4-aminophenoxy)biphenyl, bis[4-(4-aminophenoxy)phenyl] sulfone, bis[4-(3-aminophenoxy)phenyl]sulfone, 2,2-bis[4-(4-aminophenoxy)phenyl] propane, and 2,2-bis[4-(4-aminophenoxy)phenyl]hexafluoropropane.

Among these, p-phenylenediamine, m-phenylenediamine, 2,4-diaminotoluene, and 4,4′-diaminodiphenylether are preferred because of their inexpensiveness and ready availability.

The diaminotriphenyl compound is formed by linkage of two aminophenyl groups and one phenylene group, all of which are each linked through another group. The “another group” is selected from the same groups as in the diaminodiphenyl compounds. Examples of the diaminotriphenyl compounds include 1,3-bis(m-aminophenoxy)benzene, 1,3-bis (p-aminophenoxy)benzene, and 1,4-bis(p-aminophenoxy)benzene.

Examples of the diaminonaphthalenes include 1,5-diaminonaphthalene and 2,6-diaminonaphthalene.

Examples of the aminophenylaminoindanes include 5- or 6-amino-1-(p-aminophenyl)-1,3,3-trimethylindane.

Examples of the diaminotetraphenyl compounds include 4,4′-bis(p-aminophenoxy)biphenyl, 2,2′-bis[p-(p′-aminophenoxy)phenyl]propane, 2,2′-bis[p-(p′-aminophenoxy)biphenyl]propane, and 2,2′-bis[p-(m-aminophenoxy)phenyl]benzophenone.

An example of the cardo-type fluorenediamine derivatives is 9,9-bisanilinefluorene.

The number of carbon atoms of aliphatic diamine is, for example, about 2 to 15. Specific examples of aliphatic diamine include pentamethylenediamine, hexamethylenediamine, and heptamethylenediamine.

Note here that hydrogen atoms of these diamines may be a compound having at least one substituent selected from the group consisting of halogen atoms and methyl, methoxy, cyano, and phenyl groups.

There is no particular limitation to means for producing the polyamide acid, and, for example, well-known technique such as a method for reacting an acid and a diamine component in a solvent can be used.

The reaction of a tetracarboxylic dianhydride and a diamine is usually performed in a solvent. The solvent to be used for the reaction of a tetracarboxylic dianhydride and a diamine is not particularly limited and may be any solvents that can dissolve the tetracarboxylic dianhydride and the diamine without reacting with the tetracarboxylic dianhydride and the diamine. One type of solvent may be used alone or in a combination of two or more types thereof.

Examples of the solvent to be used for the reaction of a tetracarboxylic dianhydride and a diamine include nitrogen-containing polar solvents, such as N-methyl-2-pyrrolidone, N,N-dimethyl acetamide, N,N-diethylacetamide, N,N-dimethylformamide, N,N-diethylformamide, N-methylcaprolactam, and N,N,N′,N′-tetramethylurea; lactone polar solvents, such as β-propiolactone, γ-butyrolactone, γ-valerolactone, δ-valerolactone, γ-caprolactone, and ε-caprolactone; dimethyl sulfoxide; acetonitrile; fatty acid esters, such as ethyl lactate and butyl lactate; ethers, such as diethylene glycol dimethyl ether, diethylene glycol diethyl ether, dioxane, tetrahydrofuran, methyl cellosolve acetate, and ethyl cellosolve acetate; and phenol solvents, such as cresols and xylene-based mixed solvent. One type of these solvents may be used alone or in a combination of two or more types thereof. The amount of the solvent to be used is not particularly limited but is desirably an amount such that the content of the resulting polyamide acid is 5% to 50% by mass.

Among these solvents, from the viewpoint of the solubility of the resulting polyamide acid, preferred are nitrogen-containing polar solvents, such as N-methyl-2-pyrrolidone, N,N-dimethyl acetamide, N,N-diethylacetamide, N,N-dimethylformamide, N,N-diethylformamide, N-methylcaprolactam, and N,N,N′,N′-tetramethylurea.

The polymerization temperature is usually −10° C. to 120° C. and preferably 5° C. to 30° C. The polymerization time varies depending on the raw material composition to be used, and is usually 3 to 24 Hr (hours). One type of polyamide acid may be used alone or in a combination of two or more types thereof.

### [Polyimide]

The polyimide can be any known polyimide, without any limitation to its structure and molecular weight. The side chain of the polyimide may have a condensable functional group, such as a carboxy group, or a functional group enhancing the cross-linking reaction during burning. Furthermore, the soluble polyimide that can be dissolved in a solvent (S) contained in the varnish is preferable.

In order to make the polyimide soluble in a solvent (S), it is effective to use a monomer for introducing a flexible bend structure into the main chain, for example, to use an aliphatic diamine, such as ethylenediamine, hexamethylenediamine, 1,4-diaminocyclohexane, 1,3-diaminocyclohexane, or 4,4′-diaminodicyclohexylmethane; an aromatic diamine, such as 2-methyl-1,4-phenylenediamine, o-tolidine, m-tolidine, 3,3′-dimethoxybenzidine, or 4,4′-diaminobenzanilide; a polyoxyalkylenediamine, such as polyoxyethylenediamine, polyoxypropylenediamine, or polyoxybutyrenediamine; a polysiloxanediamine; 2,3,3′,4′-oxydiphthalic anhydride, 3,4,3′,4′-oxydiphthalic anhydride, or 2,2-bis(4-hydroxyphenyl)propanedibenzoate-3,3′,4,4′-tetracarboxylic dianhydride. It is also effective to use a monomer containing a functional group for improving the solubility in a solvent, for example, to use a fluorinated diamine, such as 2,2′-bis(trifluoromethyl)-4,4′-diaminobiphenyl or 2-trifluoromethyl-1,4-phenylenediamine. Furthermore, in addition to the monomer for improving the solubility of the polyimide, a monomer that is mentioned in the paragraph describing the polyamide acid may be used within a range that does not inhibit the solubility. For each of polyimide and the monomer thereof, one type thereof may be used alone or in a combination of two or more types thereof.

There is no limitation to a method for producing polyimide. Polyimide may be produced by any well-known techniques, for example, chemically imidizing or thermally imidizing polyamide acid. Examples of such polyimides include aliphatic polyimide (full-aliphatic polyimides) and aromatic polyimides, and aromatic polyimides are preferable. The aromatic polyimide may be one prepared by a thermal or chemical ring-closing reaction of a polyamide acid having repeating units represented by Formula (1) or a polyimide having repeating units represented by Formula (2). In the formulae, Ar represents an aryl group. These polyimides may be then dissolved in a solvent (S) to be used.

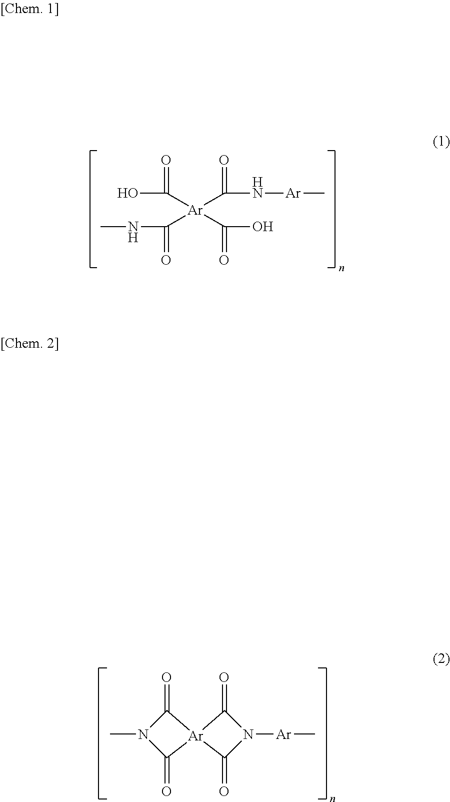

### [Polyamide-Imide and Polyamide-Imide Precursor]

Any well-known polyamide-imides can be used without limitation to the structure or molecular weight. The side chain of the polyamide-imide may have a condensable functional group, such as a carboxy group, or a functional group enhancing the cross-linking reaction during burning. Furthermore, a soluble polyamide-imide that can be dissolved in a solvent (S) to be used is preferable.

As the polyamide-imide, (i) a resin obtained by reacting an acid having a carboxyl group and an acid anhydride group in one molecule of trimellitic anhydride and the like with diisocyanate, (ii) a resin obtained by imidization of a precursor polymer (a polyamide-imide precursor) obtained by reacting a reactive derivative of the acid such as trimellitic anhydride chloride and diamine can be usually used without particular limitation.

Examples of the above-mentioned acids or the reactive derivatives include trimellitic anhydride, trimellitic anhydride halides such as trimellitic anhydride chloride, trimellitic anhydride esters, and the like.

Examples of the above-mentioned optional diamine include diamines described as an example in the description of the above-mentioned polyamide acid. A diaminopyridine compound can also be used.

The above mentioned any diisocyanate is not particularly limited, and includes, for example, a diisocyanate compound corresponding to the above-mentioned optional diamine can be used. Specific examples thereof include meta-phenylene diisocyanate, p-phenylene diisocyanate, o-tolidine diisocyanate, p-phenylene diisocyanate, m-phenylene diisocyanate, 4,4′-oxybis (phenyl isocyanate), 4,4′-diphenylmethane diisocyanate, bis[4-(4-isocyanate phenoxy) phenyl] sulfone, 2,2′-bis[4-(4-isocyanate phenoxy) phenyl]propane, 2,4-tolylene diisocyanate, 2,6-tolylene diisocyanate, 4,4′-diphenylmethane diisocyanate, 3,3′-dimethyldiphenyl-4,4′-diisocyanate, 3,3′-diethyldiphenyl-4,4′-diisocyanate, isophorone diisocyanate, hexamethylene diisocyanate, 4,4′-dicyclohexyl methane diisocyanate, m-xylene diisocyanate, p-xylene diisocyanate, naphtalen diisocyanate, and the like, can be exemplified.

As a raw material monomer of polyamide-imide, in addition to the above, it is possible to use compounds described as general formulae in Japanese Unexamined Patent Application, Publication No. S63-283705 and Japanese Unexamined Patent Application, Publication No. H2-198619. Furthermore, the imidization in the method described in the above (ii) may be any one of thermal imidization and chemical imidization. As the chemical imidization, a method of immersing a composite film (an unburned composite film) formed by using a varnish such as a polyamide-imide precursor in acetic anhydride, or a mixed solvent including acetic anhydride and isoquinoline, and the like can be used. Note here that the polyamide-imide precursor can be referred to as a polyimide precursor from the viewpoint that it is a precursor before imidization.

The polyamide-imide to be contained in a varnish may be the above-mentioned (1) a polymer obtained by reacting an acid such as trimellitic anhydride and diisocyanate with each other, (2) a polymer obtained by imidization of a precursor polymer obtained by reacting a reactive derivative of the above-mentioned acid such as trimellitic anhydride chloride and diamine with each other, or the like. The term “polyamide-imide precursor” in this specification and claims means a polymer before imidization (a precursor polymer). For each of polyamide-imide and polyamide-imide precursor, one type thereof may be used alone or in a combination of two or more types thereof. Furthermore, as the polyamide-imide, for each of the above-mentioned polymer, raw material monomer, and oligomer, one type thereof may be used alone or in a combination of two or more types thereof.

### [Polyethersulfone]

Polyethersulfone is not particularly limited as long as it can be dissolved in a solvent (S) to be used for forming a varnish. The polyethersulfone can be appropriately selected depending on the applications of use of porous films to be produced, and it may be hydrophilic or may be hydrophobic. Furthermore, the polyethersulfone may be aliphatic polyethersulfone or may be aromatic polyethersulfone. The mass average molecular weight thereof is, for example, 5000 to 1,000,000, and preferably 10,000 to 300,000.

### [Fine Particles (B)]

The fine particles (B) include fine particles (B1) and fine particles (B2) having an average particle diameter larger than that of the fine particles (B1). The fine particles (B1) have an average particle diameter of smaller than 100 nm.

When the varnish contains the fine particles (B) including the fine particles (B1) and the fine particles (B2) having an average particle diameter larger than that of the fine particles (B1) and the fine particles (B1) have an average particle diameter of smaller than 100 nm, it is possible to decrease the pore diameter of the produced porous film and improve the flow rate through the porous film, as described in Example below. This may be due to the following reasons. The pores (spherical pores) of the porous film are formed by removing the individual fine particles in the composite film (resin-fine particle composite film) formed from the varnish in a subsequent fine particle-removing step. The porous film has a structure in which spherical pores communicate with each other (hereinafter abbreviated as “continuous pore”). In the method for producing the porous film, the continuous pore is formed by removing a plurality of fine particles (B) in contact with each other in the composite film (resin-fine particle composite film) formed from the varnish in the subsequent fine particle-removing step. Sections where spherical pores communicate with each other in the continuous pore are derived from sections (contact points) where the plurality of fine particles (B) before being removed are in contact with each other. A bubble point (BP) as measured in Examples described below is an indicator of the pore diameter of the continuous pore. When using two types of fine particles (B) with different sizes i.e., smaller fine particles (B1) having an average particle diameter of smaller than 100 nm and fine particles (B2) having an average particle diameter larger than that of the fine particles (B1), the pore diameter of the continuous pore formed on the section (contact point) where the fine particles are in contact with each other depends on the particle diameter of the smaller fine particle (fine particle (B1)) and is equal to that of the continuous pore formed at the contact point between the smaller fine particles (fine particles (B1)). On the other hand, when using two types of fine particles (fine particles (B1) and fine particles (B2)) with different sizes, the number of the formed pores is decreased compared to a case using only the smaller particles (fine particles (B1)), and therefore a resistance caused by a fluid flowing through the porous film is lowered, resulting in improvement of the flow rate. Thus, by using the fine particles (B) including the smaller fine particles (B1) with an average particle diameter of smaller than 100 nm and the fine particles (B2) larger than the fine particles (B1), the pore diameter of the pores (continuous pore) in the porous film is decreased owing to the smaller fine particles (B1) with an average particle diameter of smaller than 100 nm, and the flow rate through the porous film is improved (increased) owing to the larger fine particles (B2). In other words, both decrease in the pore size of the porous film and improvement of the flow rate through the porous film can be achieved.

On the other hand, when using, as the fine particles (B), a varnish containing only smaller fine particles (B1) or a varnish containing only larger fine particles (B2), it is difficult to decrease the pore diameter of the produced porous film and improve the flow rate through the porous film.

The fine particles (B1) have an average particle diameter of smaller than 100 nm. The average particle diameter of the fine particles (B1) may be, for example, 90 nm or smaller, 60 nm or smaller, or 30 nm or smaller. Furthermore, the average particle diameter of the fine particles (B1) may be, for example, 10 nm or larger.

The average particle diameter of the fine particles (B2) only needs to be larger than the average particle diameter of the fine particles (B1) and may be smaller than 100 nm. The average particle diameter of the fine particles (B2) may be, for example, 40 nm or larger, 70 nm or larger, 90 nm or larger, 100 nm or larger, or 250 nm or larger. The average particle diameter of the fine particles (B1) may be, for example, 400 nm or smaller, 300 nm or smaller, or 100 nm or smaller.

The difference in the average particle diameter between the fine particles (B1) and the fine particles (B2) may be, but is not limited to, for example, 5 nm or larger and 250 nm or smaller, 10 nm or larger and 100 nm or smaller, or 20 nm or larger and 60 nm or smaller.

Specific examples of the average particle diameter include combinations of the following 1) to 5).
1) Average particle diameter of fine particles (B1): 70 nm or larger and 90 nm or smaller Average particle diameter of fine particles (B2): 250 nm or larger and 350 nm or smaller
2) Average particle diameter of fine particles (B1): 70 nm or larger and 90 nm or smaller Average particle diameter of fine particles (B2): 90 nm or larger and 110 nm or smaller
3) Average particle diameter of fine particles (B1): 40 nm or larger and 60 nm or smaller Average particle diameter of fine particles (B2): 70 nm or larger and 90 nm or smaller
4) Average particle diameter of fine particles (B1): 10 nm or larger and 30 nm or smaller Average particle diameter of fine particles (B2): 70 nm or larger and 90 nm or smaller
5) Average particle diameter of fine particles (B1): 10 nm or larger and 30 nm or smaller Average particle diameter of fine particles (B2): 40 nm or larger and 60 nm or smaller

In the present specification, the average particle diameter of the fine particles (B) is represented by D50, which means a particle diameter at a 50% integral value in a volume-based particle size distribution determined by a laser diffraction scattering method.

A ratio of the average particle diameter (D2) of the fine particles (B2) to the average particle diameter (D1) of the fine particles (B1) (D2/D1) is preferably 1.2 to 6.0.

A ratio of the mass of the fine particles (B2) to the mass of the fine particles (B1) is preferably 0.10 to 0.90, more preferably 0.20 to 0.80, even more preferably 0.30 to 0.70, particularly preferably 0.40 to 0.60.

As the material for the fine particles (B), any known material can be adopted without particular limitation as long as the material is insoluble in the solvent (S) contained in the varnish and can be removed from the composite film (resin-fine particle composite film) formed from the varnish in the fine particle-removing step. The material may be an inorganic material or an organic material. The materials of the fine particles (B1) and the fine particles (B2) may be different, but are preferably the same.

The fine particles (B) made of an inorganic material may be inorganic oxide fine particles, and specific examples thereof include metal oxides particles such as silica (silicon dioxide) fine particles, titanium oxide fine particles, and alumina (Al₂O₃) fine particles. Examples of silica include colloidal silica. In particular, it is preferable to select monodisperse spherical silica particles because uniform pores can be formed.

The fine particles made of an organic material may be organic polymer fine particles made of high-molecular-weight olefins (e.g., polypropylene and polyethylene), polystyrene, epoxy resins, cellulose, polyvinyl alcohol, polyvinyl butyral, polyester, polyether, or the like.

Furthermore, it is preferable that the fine particles (B) preferably have a high sphericity and a low particle diameter distribution index. Fine particles (B) satisfying these conditions show excellent dispersibility in the varnish and can be used without causing aggregation with one another.

One type of fine particle (B) may be used alone or in a combination of two or more types thereof.

### [Solvent (S)]

The solvents (S) are not particularly limited as long as they can solve a resin component (A) which includes polyamide acid, polyimide, a polyamide-imide precursor, polyamide-imide, and/or polyethersulfone and does not solve fine particles (B). Examples of the solvent (S) include solvents described as an example of a solvent to be used for reaction of tetracarboxylic dianhydride and diamine. One type of solvent (S) may be used alone or in a combination of two or more types thereof. When the resin component (A) contains polyethersulfone, examples of the solvent (S) include polar solvents such as diphenylsulfone, dimethylsulfone, dimethylsulfoxide, benzophenone, tetrahydrothiophene-1,1-dioxide, and 1,3-dimethyl-2-imidazolidinone, in addition to the above-mentioned nitrogen-containing polarity solvent.

### [Dispersant]

In order to uniformly disperse fine particles (B) in a varnish, a dispersant together with fine particles (B) may be added. Addition of the dispersant allows further uniform mixing of the fine particles (B) in a varnish, and further allows uniform dispersion of the fine particles (B) in a film including a varnish. As a result, dense openings are provided on the surface of the finally obtained porous film, and the front and rear surfaces can be allowed to efficiently communicate with each other, thus improving the air permeability of the porous film. Furthermore, addition of the dispersant easily improves drying of the varnish, and easily improves peelability of the formed unburned composite film from a substrate and the like.

The dispersant is not particularly limited and any known dispersant may be used. Examples of the dispersant include, but not limited to, anionic surfactants, such as salts of coconut fatty acid, salts of sulfonated castor oil, lauryl sulfate, polyoxyalkylene allylphenyl ether sulfate, alkylbenzenesulfonic acid, alkylbenzene sulfonate, alkyldiphenyl ether disulfonate, alkylnaphthalene sulfonate, dialkyl sulfosuccinate, isopropyl phosphate, polyoxyethylene alkyl ether phosphate, and polyoxyethylene allylphenyl ether phosphate; cationic surfactants, such as oleylamine acetate, lauryl pyridinium chloride, cetyl pyridinium chloride, lauryl trimethylammonium chloride, stearyl trimethylammonium chloride, behenyl trimethylammonium chloride, and didecyl dimethylammonium chloride; amphoteric surfactants, such as coconut alkyl dimethylamine oxide, fatty acid amide propyl dimethyl amine oxide, alkyl polyaminoethyl glycine hydrochloride, amide betaine surfactant, alanine surfactant, and lauryl iminodipropionic acid; polyoxyalkylene primary alkyl ether or polyoxyalkylene secondary alkyl ether nonionic surfactants, such as polyoxyethylene octyl ether, polyoxyethylene decyl ether, polyoxyethylene lauryl ether, polyoxyethylene laurylamine, polyoxyethylene oleylamine, polyoxyethylene polystyryl phenyl ether, and polyoxyalkylene polystyryl phenyl ether; other polyoxyalkylene nonionic surfactants, such as polyoxyethylene dilaurate, polyoxyethylene laurate, polyoxyethylenated castor oil, polyoxyethylenated hydrogenated castor oil, sorbitan laurate, polyoxyethylene sorbitan laurate, and fatty acid diethanolamide; fatty acid alkyl esters, such as octyl stearate and trimethylolpropane tridecanoate; and polyether polyols, such as polyoxyalkylene butyl ether, polyoxyalkylene oleyl ether, and trimethylol propane tris(polyoxyalkylene) ether. These dispersants may be used as a mixture of two or more types thereof.

From the view point of, for example, the film formability, the content of the dispersant in the varnish is preferably 0.01% by mass or more and 5% by mass or less, more preferably 0.05% by mass or more and 1% by mass or less, and further more preferably 0.1% by mass or more and 0.5% by mass or less, with respect to the mass of the fine particles (B).

The production method for the above-mentioned composition (varnish) for producing the porous film is not particularly limited. The varnish is typically produced by: preparing a fine particle dispersion liquid by dispersing the fine particles (B) into a solvent; preparing a resin solution containing the resin component (A); and kneading the fine particle dispersion liquid and the resin solution together to adjust the concentration.

Preferably, the varnish has a viscosity of 0.1 to 3 Pa·s at 25° C., and a solid content concentration of 10% by mass or higher and 50% by mass or lower. The varnish is preferably produced by kneading for, preferably 2 minutes or longer and 10 hours or shorter, more preferably 2 minutes or longer and 60 minutes or shorter. Note here that the viscosity of the varnish is measured using an E-type viscometer. The varnish can be kneaded using a rotation-revolution type mixer (product name: “Awatori Rentarou” manufactured by Thinky Corporation), a planetary mixer, a bead mill, or the like. The kneading step may include a dispersion treatment, in which, using a disperser having a flow passage with a cross-sectional area of 1960 μm² or larger and 785,000 μm² or smaller, a mixture (slurry) pressurized to 50 MPa or higher and containing a fine particle dispersion liquid and a resin solution is allowed to pass through the flow passage. A method for such a dispersion treatment to allow the mixture to pass through the flow passage is described in Japanese Unexamined Patent Application No. 2020-104105.

### <<Method for Producing Porous Film>>

The method for producing the porous film includes: forming, on the substrate, the composite film made of the above-mentioned composition for producing the porous film; and removing the fine particles from the composite film. Also, in the method for producing the porous film, the resin component (A) may contain at least one of polyamide acid and polyamide-imide precursor, and the composite film may be burned after the composite film-forming step and before the fine particle-removing step.

### [Composite Film-Forming Step (Production of Unburned Composite Film)]

In the composite film-forming step, the composite film made of the above-mentioned composition (varnish) for producing the porous film is formed on a substrate. The composite film (hereinafter also referred to as “unburned composite film”) may be formed (film formation) directly on the substrate or on a lower layer film different from the above-mentioned unburned composite film. After the unburned composite film is formed from the above-mentioned varnish (the composition for producing the porous film), an upper layer film different from the above-mentioned unburned composite film may be further formed. In this application, the method of forming the unburned composite film on the substrate also includes the method of providing the lower layer film on the substrate, as well as the method of forming the unburned composite film from the varnish and then further forming the upper layer film different from the above-mentioned unburned composite film. However, if the resin component (A) contained in the varnish is a polyamide acid or a polyamide-imide precursor and a material requiring no burning step is used for the upper layer film, the upper layer film may be formed on the resin-fine particle composite film after burning. It is preferable that the composite film made of the varnish (unburned composite film) is formed as a single layer film on the substrate. The unburned composite film can be formed, for example, by applying the varnish on the substrate or the lower layer film, and drying the film at 0 to 100° C. under normal pressure or vacuum, preferably at 10 to 100° C. under normal pressure. Examples of the substrate include a PET film, a SUS substrate, a glass substrate, and the like.

Examples of the lower layer film (or an upper layer film) include a lower (or upper) layer unburned composite film formed using a varnish for forming a lower (or upper) layer film containing a resin component which includes polyamide acid, polyimide, a polyamide-imide precursor, polyamide-imide, and/or polyethersulfone, fine particles, and a solvent, wherein the content of the fine particles is more than 40% by volume and not more than 81% by volume with respect to the total of the resin and the fine particles. The lower layer (or upper layer) unburned composite film may be formed on the substrate. When the content of the fine particles is more than 40% by volume, the particles are uniformly dispersed; and when the content of the fine particles is not more than 81% by volume, the particles are dispersed without causing aggregation of particles. Consequently, pores can be formed uniformly in the porous film. Furthermore, when the content of the fine particles is within the above-mentioned range, when the lower layer (or upper layer) unburned composite film is formed on the substrate, even when the substrate is not provided with a mold release layer in advance, mold releasability after film formation can be easily secured.

Note here that the fine particles to be used for the varnish for forming a lower (or upper) layer film and the fine particles (B) to be used for the varnish may be the same as or different from each other. In order to increase the density of pores in the lower (or upper) layer unburned composite film, it is preferable that the fine particles to be used for the varnish for forming the lower (or upper) layer film has a particle diameter distribution index that is equal to or smaller than that of the fine particles (B) to be used for the varnish. Alternatively, it is preferable that the fine particles to be used for a varnish for the lower (or upper) layer film has a sphericity that is equal to or smaller than that of the fine particles (B) to be used for the varnish.

Furthermore, the average particle diameter of fine particles to be used for the varnish for the lower (or upper) layer film may be the same as or different from the average particle diameter of the fine particles (B) of the varnish. The average particle diameter may be appropriately set to be in a range from 10 to 5000 nm depending on the application of use. When the varnish for the lower (or upper) layer film is used, it is preferable that the varnish is used for the upper layer, and a varnish for the lower layer film having different average particle diameter or a particle diameter distribution index of fine particles is used in combination.

Furthermore, the content of the fine particles to be used for the varnish for forming a lower (or upper) layer film may be larger or smaller than that of the above-mentioned varnish. Suitable examples of the components such as a resin component, fine particles, and a solvent included in the varnish for forming a lower (or upper) layer film are the same as those in the above-mentioned varnish. The varnish for forming a lower (or upper) layer film can be prepared by the same method as that of the above-mentioned varnish. The lower layer unburned composite film can be formed by, for example, applying the varnish for a lower layer film onto the substrate, followed by drying at normal pressure or under vacuum at 0 to 100° C., and preferably at normal pressure at 10 to 100° C. The same is true to the film formation conditions of the upper layer unburned composite film.

Furthermore, examples of the lower (or upper) layer film include lower layer films made of fiber materials such as cellulose resin, non-woven fabric (for example, polyimide non-woven fabric or the like; a fiber diameter is, for example, about 50 nm to about 3000 nm), and a polyimide film.

Furthermore, a burning step of burning the unburned composite film or a laminated film of the unburned composite film and the lower (or upper) layer film to obtain a polyimide-fine particle composite film is carried out. When the unburned composite film or the lower layer unburned composite film is formed on the substrate, burning may be carried out as it is, or the unburned composite film or the laminated film of the unburned composite film and the lower unburned composite film may be peeled off from the substrate before carrying out the burning step.

Note here that when the above-mentioned lower (or upper) layer film in a laminated film is a lower (or upper) layer unburned composite film formed using a varnish for forming a lower (or upper) layer film, and the composition of the varnish for forming a lower (or upper) layer film is the same as the composition of the varnish, the laminated film of the above-mentioned composite film (unburned composite film) and the above-mentioned lower (or upper) layer film is substantially one layer (single layer), but in this specification, it is referred to as a laminated film.

When the composite film (unburned composite film) or the laminated film of the unburned composite film and the lower (or upper) layer unburned composite film is peeled off from the substrate, the substrate provided with a mold release layer in advance can also be used in order to further enhance the releasability of the film. In a case of providing the substrate with a mold release layer in advance, the mold release agent is applied onto the substrate and is dried or baked before the application of the varnish. The mold release agent used here may be a known mold release agent, such as an alkylphosphate ammonium salt-based or fluorine-based agent or silicon, without particular restrictions. When the dried unburned composite film is peeled off from the substrate, a slight amount of the mold release agent remains on the surface of the peeled unburned composite film and may lead to discoloration during burning and adverse effects on the electrical characteristics. The mold release agent should therefore be removed as much as possible. In order to remove the mold release agent, a washing step of washing the unburned composite film or the laminated film of the unburned composite film and the lower layer unburned composite film peeled off from the substrate with an organic solvent may be introduced.

Alternatively, when the substrate is directly used, as it is, without providing a mold release layer in formation of the unburned composite film or the lower layer unburned composite film, the step of forming the mold release layer and the washing step can be omitted. Furthermore, in the production of an unburned composite film, before the below-mentioned burning step, an immersion step into a water-containing solvent, a pressing step, and a drying step after the immersion step may be optionally provided.

### [Burning Step (Production of Resin-Fine Particle Composite Film)]

In the burning step, the composite film is burned after the composite film-forming step and before the fine particle-removing step. When a resin component (A) contained in the varnish is a polyamide acid or a polyamide-imide precursor, the composite film (unburned composite film) is subjected to heat treatment as post-treatment (burning step) to be formed into a composite film (resin-fine particle composite film) composed of a resin made of polyimide and/or polyamide-imide and fine particles (B). Note here that, when the resin component (A) contained in the varnish is polyimide, polyamide-imide, or polyethersulfone, the method may or may not include the burning step.

In the composite film-forming step, when the unburned composite film is formed on a lower layer film that is different from the unburned composite film, the lower layer film together with the unburned composite film is burned in the burning step.

The burning temperature in the burning step varies depending on the structures of the unburned composite film and the lower layer film and the presence or absence of a condensing agent, but the temperature is preferably 120° C. to 450° C., and more preferably 150° C. to 400° C. In a case of using an organic material for the fine particles (B), the burning temperature need to be set to a temperature lower than the thermal decomposition temperature of the organic material. When the resin component (A) contained in the varnish is polyamide acid, in the burning step, imidization is preferably completed.

The burning can be performed by, for example, a method of increasing the temperature from room temperature to 400° C. over three hours and then holding 400° C. for 20 minutes or a method of stepwise drying-thermal imidization by stepwise increasing the temperature by 50° C. from room temperature to 400° C. (holding the temperature of each step for 20 minutes) and finally holding 400° C. for 20 minutes. When the unburned composite film is formed on the substrate and the unburned composite film is peeled from the substrate once, an end of the unburned composite film may be fixed to, for example, a frame made of SUS stainless steel to prevent deformation.

The thickness of the resulting resin-fine particle composite film can be determined by, for example, measuring the thicknesses of a plurality of positions with a micrometer or the like and averaging the thicknesses. Preferred average thickness varies depending on the application of use of porous film, however, is preferably 5 to 500 μm and more preferably 10 to 100 μm, and further preferably 15 to 30 μm in the use as a separator. The average thickness is preferably 5 to 500 μm and more preferably 10 to 300 μm, and further preferably 20 to 150 μm in the use as a filter or the like.

### [Fine Particle-Removing Step (Porosification of Resin-Fine Particle Composite Film)]

In the fine particle-removing step, the fine particles (B) are removed from the composite film after the composite film-forming step (if a burning step is performed, the composite film after the burning step (resin-fine particle composite film)). The porous film can be produced with high reproducibility by removing the fine particles (B) using an appropriately-selected method.

For example, when silica is employed as the material of the fine particles (B), the silica can be removed by treating the resin-fine particle composite film with, for example, a low-concentration hydrogen fluoride solution to dissolve the silica.

An organic material can also be selected as the material of the fine particles (B). Any organic material, which is decomposed at a temperature lower than resin contained in the resin-fine particle composite film, may be used, without particular limitation. Examples thereof include resin fine particles composed of linear polymers and known depolymerizable polymers. The linear polymer usually has a molecular chain that is randomly cleaved during thermal decomposition; and the depolymerizable polymer is decomposed into a monomer during thermal decomposition. Both of them are decomposed into a low molecular weight substance or to CO₂ and disappear from the porous film. A decomposition temperature of the resin fine particles to be used is preferably 200° C. to 320° C. and more preferably 230° C. to 260° C. A decomposition temperature of 200° C. or more allows formation of a film even if the varnish contains a high boiling point solvent and broadens the selection of burning conditions of the resin-fine particle composite film. Furthermore, a decomposition temperature of less than 320° C. allows the resin fine particles alone to disappear without thermally damaging resin contained in the resin-fine particle composite film.

The total thickness of the porous film is not particularly limited, and is preferably 5 μm to 500 μm, more preferably 10 μm to 100 μm, and further preferably 15 μm to 30 μm, when, for example, the porous film is used for a separator or the like. The thickness is preferably 5 μm to 500 μm, more preferably 10 μm to 300 μm, and further preferably 20 μm to 150 μm, when, for example, the porous film is used for a filter or the like. Similar to the measurement of the resin-fine particle composite film, the above-mentioned thickness can be determined by, for example, measuring thicknesses of a plurality of positions with a micrometer or the like and averaging the thicknesses.

When the porous film is formed of two or more types of compositions for producing a porous film or the like, the ratio in the thickness direction of the region formed by each composition for producing a porous film may be appropriately determined depending on the application of use of the porous film. When a porous film has two regions, that is, a layer (I) by composition for producing a porous film and a layer (II) by the other composition for producing a porous film, the ratio ((I):(II)) of each region in the thickness direction may be adjusted to, for example, 1:99 to 99:1, preferably 5:95 to 95:5. The thickness of each layer can be calculated by averaging thicknesses at a plurality of positions in a cross section of the porous film by observing under, for example, a scanning electron microscope (SEM).

### [Resin-Removing Step]

A method for producing a porous film may include a resin-removing step of removing at least a part of a resin portion of a resin-fine particle composite film before the fine particle-removing step, or removing at least a part of the porous film after the fine particle-removing step. When at least a part of a resin portion of the resin-fine particle composite film or at least a part of the porous film is removed, the opening rate of the porous film of the final product can be improved as compared with the case where at least a part of the resin portion or at least a part of the porous film is not removed.

The step of removing at least a part of the resin portion or the step of removing at least a part of the porous film can be carried out by a usual chemical etching or physical removing method, or a method combining these methods.

The chemical etching method includes treatment using a chemical etchant such as an inorganic alkaline solution or an organic alkaline solution. An inorganic alkaline solution is preferable. Examples of the inorganic alkaline solution include a hydrazine solution including hydrazine hydrate and ethylenediamine; a solution of alkaline metal hydroxide such as potassium hydroxide, sodium hydroxide, sodium carbonate, sodium silicate, and sodium metasilicate; an ammonium solution; an etchant including alkali hydroxide, hydrazine, and 1,3-dimethyl-2-imidazolidinone as a main component, or the like. Examples of the organic alkaline solution include an alkaline solution of primary amines such as ethyl amine and n-propyl amine; secondary amines such as diethyl amine and di-n-butylamine; tertiary amines such as triethylamine and methyl diethyl amine; alcohol amines such as dimethyl ethanol amine and triethanolamine; quaternary ammonium salts such as tetramethylammonium hydroxide and tetraethylammonium hydroxide; cyclic amines such as pyrrole and piperidine, or the like.

As a solvent for each solution, pure water and alcohols can be appropriately selected. Furthermore, solvents in which an appropriate amount of surfactant is added can be used. An alkali concentration is, for example, 0.01 to 20% by mass.

Furthermore, examples of the physical method include dry etching by plasma (oxygen, argon, etc.), corona discharge, or the like, a method for treating a surface of a film by dispersing abrasives (for example, alumina (rigidity 9), or the like) in a liquid and irradiating the surface of a film with the liquid at the irradiation rate of 30 to 100 m/s, and the like.

The above-mentioned methods are preferable because they are applicable to the resin-removing step both before and after the fine particle-removing step.

On the other hand, as the physical method that can be applied only to the resin-removing step carried out after the fine particle-removing step, a method of compression bonding a mount film (for example, a polyester film such as a PET film) whose subject surface is wetted with liquid and then peeling a porous film from the mount film after drying or without drying can be employed. Due to the surface tension of the liquid or electrostatic adhesion, the porous film is peeled from the mount film with only the surface layer of the porous film left on the mount film.

The above-described method for producing a porous film makes it possible to produce a porous film having a small pore diameter and an improved flow rate.

The produced porous film can have an IPA flow rate of, for example, 0.065 mL/(min-cm²) or higher, further 0.110 mL/(min·cm²) or higher, as measured by the method described in [IPA Flow Rate (FR)] below. The produced porous film can have a bubble point of, for example, 168 psi or higher, 188 psi or higher, further 200 psi or higher, as measured by the method described in [Bubble Point (BP)] below. The bubble point is an indicator for the pore diameter of the continuous pore. The higher the bubble point is, the smaller the pore diameter is.

The produced porous film has a structure in which spherical pores communicate with each other (continuous pore). An opening portion in the porous film refers to a portion where the continuous pore is opened on the surface of the porous film.

The spherical shape with respect to a pore shape includes a true-spherical shape, but it is not necessarily limited to a true-spherical shape. The spherical shape is only required to be a substantially true-spherical shape, and shapes that can be recognized to be substantially a true-spherical shape when an enlarged image of a pore part is visually observed is also included in spherical shapes. Specifically, in a spherical pore, a surface that defines a pore part is a curved surface, and a true-spherical shape or substantially a true-spherical shape are only required to be defined by the curved surface.

Typically, individual spherical pores are formed in the subsequent fine particle-removing step by removing individual fine particles (B) existing in the composite film (resin-fine particle composite film). The continuous pore is formed in the subsequent fine particle-removing step by removing a plurality of fine particles (B) that are present in contact with each other in resin-fine particle composite film in the method for producing a porous film. A section in which spherical pores communicate with each other in the continuous pore is derived from a section in which a plurality of fine particles (B) before being removed are brought into contact with each other.

A diameter of the opening portion in the porous film may be appropriately varied in range of, for example, 100 nm to 5000 nm depending on the applications of use of the porous film. The diameter of the opening portion is equal or substantially equal to the diameter of a spherical pore constituting the continuous pore. The continuous pore formed by linking spherical pores each having such a diameter satisfactorily allows fluid to pass through the porous film. The porous film has a continuous pore inside thereof as a fluid flow passage penetrating in a thickness direction of the porous film. This enables a fluid to penetrate from one main surface to the other main surface of the porous film. Furthermore, when a laminated body is used as a filter, a fluid passes through the inside of a porous film while it is brought into contact with curved surfaces defining individual spherical pores. The contact area of the fluid inside the porous film is relatively large because a continuous pore of spherical pores is provided. Therefore, when a fluid is allowed to pass through a laminated body including a porous film, it is considered that minute substances that are present in the fluid are easily adsorbed to spherical pores in the porous film.

### <<Porous Film>>

The porous film contains at least one resin component selected from a group consisting of polyimide, polyamide-imide, and polyethersulfone. The porous film is produced by a production method including forming a composite film made of the above-mentioned composition (varnish) for producing the porous film on a substrate, and removing the fine particles (B) from the composite film. That means, the porous film can be produced by the above-mentioned method for producing the porous film. Since the porous film is produced from the composition (varnish) for producing the porous film, a porous film with a small pore diameter and an improved (increased) flow rate can be provided.

### EXAMPLES

The present invention will now be more specifically described with reference to Examples, but the scope of the present invention is not limited to Examples below.

### Examples 1 to 6 and Comparative Examples 1 to 3

A silica dispersion liquid (including 0.5% by mass of dispersant with respect to silica) was added to a polyamide acid solution so that an amount of polyamide acid was 30% by mass and a mass of silica was 70% by mass with respect to the total mass of polyamide acid (resin component (A)) and silica (fine particles (B)). Furthermore, organic solvents (1) and (2) were respectively added to the solution so that a ratio between the organic solvent (1) and the organic solvent (2) was 90:10 as the solvent composition in the whole final composition (composition (varnish) for producing the porous film). The resulting mixture was agitated in a 1000 mL container using agitation blades at 4000 rpm for 30 minutes to disperse the mixture. Subsequently, a dispersion treatment was repeated ten times, in which, using a disperser with a flow passage having a diameter of 60 μm (cross-sectional area: 2826 μm²) manufactured by YOSHIDA KIKAI CO., LTD., the mixture was allowed to pass through the flow passage at 200 MPa, to prepare a porous film producing composition (varnish) with a solid content concentration of 30% by mass. A ratio between polyamide acid and silica (polyamide acid:silica) in the resulting varnish was 38:62 by volume and 30:70 by mass. Note here that a polyamide acid solution, an organic solvent, a dispersant, and fine particles mentioned below were used. As silica, those of the types and masses listed in Table 1 were used. Table 1 also lists ratios of the average particle diameter of silica (ratio of the average particle diameter (D2) of the fine particles (B2) to the average particle diameter (D1) of the fine particles (B1) (D2/D1)).
Polyamide acid solution: reaction product of pyromellitic dianhydride and 4,4′-diaminodiphenyl ether (solid content: 20% by mass (organic solvent: N,N-dimethyl acetamide))
Organic solvent (1): N,N-dimethyl acetamide (DMAc)
Organic solvent (2): gamma butyrolactone
Dispersant: polyoxyethylene secondary alkyl ether dispersant
Fine particles (B): silica having an average particle diameter of 50 nm, silica having an average particle diameter of 80 nm, and/or silica having an average particle diameter of 100 nm

The obtained composition for producing the porous film was applied onto a polyethylene terephthalate (PET) film as a substrate using an applicator, and dried at 90° C. for 5 minutes to form a composite film on the substrate (composite film-forming step). This composite film (unburned composite film) was placed in an oven, and burned at 380° C. for 15 minutes to complete imidization to obtain a resin-fine particle composite film (burning step). Thereafter, the resin-fine particle composite film was peeled off from the substrate. The peeled resin-fine particle composite film was immersed in a hydrogen fluoride (HF) solution for 10 minutes to remove silica fine particles contained in the film (fine particle-removing step). Subsequently, the film was washed with water and dried to obtain polyimide porous films of Examples 1 to 3 and Comparative Examples 1 and 2 individually having a thickness of 40 μm, and polyimide porous films of Examples 4 to 7 and Comparative Example 3 individually having a thickness of 20 μm.

IPA flow rates (FR) and bubble points (BP) of the obtained polyimide porous films of Examples and Comparative Examples were measured by the following methods. The results are presented in Table 1.

### [IPA Flow Rate (FR)]

Each polyimide porous film was cut out into a membrane filter size of a 47 mm diameter and attached to an in-line filter holder. Subsequently, isopropyl alcohol (IPA) was filtered through the porous film by pressurization with air at 0.1 MPa from the primary side (upstream of the flow passage of the porous film), and the flow rate was measured. The measurement was performed at 25° C. In Table 1, the flow rate is expressed by mL per 1 minute per 1 cm².

### [Bubble Point (BP)]

A bubble point (BP) was measured in accordance with American Society for Testing and Materials (ASTM) F316-86 and Japanese Industrial Standards (JIS) K 3832. Specifically, each polyimide porous film was cut out into a membrane filter size of a 47 mm diameter and attached to a holder for measuring the bubble point. The secondary side of the film (downstream of the flow passage of the porous film) was moistened with a fluorine-based solvent (hydrofluoroether: Novec 7200, manufactured by 3M Company), gradually pressurized with air from the primary side, and a pressure at which bubbles were generated on the secondary side was measured. The measurement was performed at normal temperature (25° C.).

TABLE 1

| | Fine particle(B) | | | | | | | | |
|---|---|---|---|---|---|---|---|---|---|
| | Fine particle(B1) | | | Fine particle(B2) | | | | | |
| | (Silica) | | | (Silica) | | | | | |
| | Average | | | Average | | | | | |
| | particle | | | particle | | | | Evaluation result | |
| | diameter | | Parts | diameter | | Parts | | IPA FR | BP |
| | D1 | | by mass | D2 | | by mass | D2/D1 | (mL/min · cm²) | (psi) |
| Example 1 | 80 | nm | 70 | 100 | nm | 30 | 1.25 | 0.110 | 194.0 |
| Example 2 | 80 | nm | 50 | 100 | nm | 50 | 1.25 | 0.119 | 202.4 |
| Example 3 | 80 | nm | 30 | 100 | nm | 70 | 1.25 | 0.124 | 188.6 |
| Example 4 | 50 | nm | 75 | 80 | nm | 25 | 1.6 | 0.068 | 229.0 |
| Example 5 | 50 | nm | 50 | 80 | nm | 50 | 1.6 | 0.076 | 224.0 |
| Example 6 | 50 | nm | 25 | 80 | nm | 75 | 1.6 | 0.093 | 220.0 |
| Example 7 | 50 | nm | 20 | 80 | nm | 80 | 1.6 | 0.095 | 212.0 |

| | | | | | | | | |
|---|---|---|---|---|---|---|---|---|
| Comparative | 80 | nm | 100 | — | — | — | 0.096 | 196.4 |
| Example 1 | | | | | | | | |
| Comparative | 100 | nm | 100 | — | — | — | 0.159 | 112.4 |
| Example 2 | | | | | | | | |
| Comparative | 50 | nm | 100 | — | — | — | 0.058 | 235.0 |
| Example 3 | | | | | | | | |

As presented in Table 1, in Examples 1 to 3 the porous film forming composition containing the fine particles (B) including the fine particles (B1) with an average particle diameter of smaller than 100 nm (80 nm) and the fine particles (B2) with an average particle diameter of larger than that of the fine particles (B1), the bubble points were equivalent to that in Comparative Example 1 using the porous film forming composition containing only the fine particles (B1). In other words, it can be said that, in Examples 1 to 3, the porous films had a small pore diameter equivalent to that in Comparative Example 1 using the porous film forming composition containing, as the fine particles (B), only the smaller fine particles (B1) with an average particle diameter of smaller than 100 nm (80 nm). Also, in Examples 1 to 3, the IPA flow rate (FR) was higher than that in Comparative Example 1, and thus the flow rate was improved. From these results, it can be said that the porous films with a small pore diameter and an improved flow rate were produced in Examples 1 to 3. In Examples 4 to 7 using the porous film forming composition containing the fine particles (B) including the fine particles (B1) with an average particle diameter of smaller than 100 nm (50 nm) and the fine particles (B2) with an average particle diameter larger than that of the fine particles (B1), the bubble points were equivalent to that in Comparative Example 3 using the porous film forming composition containing only the fine particles (B1). In other words, it can be said that, in Examples 4 to 7, the porous films had a small pore diameter equivalent to that in Comparative Example 3 using the porous film forming composition containing, as the fine particles (B), only the smaller fine particles (B1) with an average particle diameter of smaller than 100 nm (50 nm). Also, in Examples 4 to 7, the IPA flow rate (FR) was higher than that in Comparative Example 3, and thus the flow rate was improved. From these results, it can be said that the porous films with a small pore diameter and an improved flow rate were produced in Examples 4 to 7. From Examples 1 to 3 and Examples 4 to 7, it can be seen that the flow rate is further improved when the ratio of the mass of the fine particles (B2) to the mass of the fine particles (B1) is increased. On the other hand, from Comparative Examples 1 to 3, it can be seen that, when using the porous film producing composition containing only smaller fine particles (B1) or the porous film producing composition containing only the larger fine particles (B2), the produced porous film has a low flow rate or a large pore diameter.

What is claimed is:

1. A composition for producing a porous film, the composition comprising at least one resin component (A) selected from a group consisting of polyamide acid, polyimide, a polyamide-imide precursor, polyamide-imide, and
polyethersulfone, fine particles (B), and a solvent (S), the fine particles (B) comprising fine particles (B1) and fine particles (B2) having an average particle diameter larger than that of the fine particles (B1),
the fine particles (B1) having an average particle diameter of smaller than 100 nm.

2. The composition according to claim 1, wherein a ratio (D2/D1) of the average particle diameter (D2) of the fine particles (B2) to the average particle diameter (D1) of the fine particles (B1) is 1.2 to 6.0.

3. The composition according to claim 1, wherein the fine particles (B) are inorganic oxide fine particles.

4. The composition according to claim 3, wherein the fine particles (B) are at least one selected from a group consisting of silica fine particles, titanium oxide fine particles, and alumina fine particles.

5. The composition according to claim 1, wherein a ratio of a mass of the fine particles (B2) to a mass of the fine particles (B1) is 0.10 to 0.90.

6. A method for producing a porous film, comprising:
forming, on a substrate, a composite film made of the composition for producing a porous film according to claim 1; and
removing the fine particles from the composite film.

7. The method according to claim 6, wherein the resin component (A) comprises at least one of polyamide acid or a polyamide-imide precursor, and
the method comprises burning the composite film after forming the composite film and before removing the fine particles.

8. A porous film comprising at least one resin component selected from a group consisting of polyimide, polyamide-imide, and polyethersulfone,
the porous film being produced by a production method comprising: forming, on a substrate, a composite film made of the composition for producing a porous film according to claim 1; and removing the fine particles from the composite film.
